(19) United States
(12) Patent Application Publication
(10) Pub. No.: US 2002/0184013 A1
(43) Pub. Date: Dec. 5, 2002

(54) Method of masking noise modulation and disturbing noise in voice communication

(75) Inventor: Michael Walker, Baltmannsweiler (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/125,596

(22) Filed: Apr. 19, 2002

(30) Foreign Application Priority Data
Apr. 20, 2001 (DE) 101 19 277.0

(51) Int. Cl. G10L 21/02

(52) U.S. Cl. 704/226

(57) ABSTRACT

During echo cancellation in telecommunications networks with nonlinear transfer functions, noise in time intervals in which echo occurs is attenuated together with the echo much more than noise during echo-free time intervals. This results in disturbing audible noise modulation. To achieve naturally sounding speech transmission, during time intervals in which echoes were cancelled, synthetic, particularly spectrally weighted, noise is inserted in the noise gaps as a function of noise estimated during speech pauses. By a weighting factor the temporal variation of the inserted noise is determined, so that the auditory sensation of the human ear can be taken into account and noiseless insertion of the noise is achieved.

### BACKGROUND OF THE INVENTION

The invention is based on a priority application DE 10119277.0 which is hereby incorporated by reference.

This invention relates to a method which improves natural speech transmission in telecommunications systems. In such telecommunications systems, objectionable echoes occur during speech transmission. In telecommunications terminals with hands-free facilities, for example, echoes are produced by acoustic coupling from the loudspeaker to the microphone, so that part of the received signal is coupled from the loudspeaker via the air path and possibly a housing to the microphone, and thus to the talker at the distant end of the telecommunications system. These echoes are called “acoustic echoes”. Furthermore, so-called line echoes occur, which are due to mismatching of 2-wire/4-wire hybrids, i.e., devices that couple two-wire analog to four-wire digital circuits in telecommunications systems.

If an unambiguous correlation exists between transmitted signal and received echo, echoes are compensated for by the use of adaptive finite impulse response (FIR) filters, see DE-A-44 30 189. However, this method fails in mobile radio systems, for example, where audio/video codecs and encryption algorithms are used, because as a result of the speech-encoding and -decoding processes, the correlation between transmitted signal and received echo no longer exists, which results in nonlinear transfer functions from the transmitter to the receiver and vice versa. Furthermore, nonlinearities may be caused, for example, by vibrations of a telecommunications terminal which are excited by the loudspeaker. In those cases, echo cancellation requires the use of processing units with nonlinear function (nonlinear processors-NLPs). An intelligent economical nonlinear function can be implemented with a compandor, for example, see DE-A-196 11 548. If nonlinear techniques are used for echo cancellation, however, noise in time intervals in which echoes occur is attenuated along with the echoes much more than noise in echo-free intervals, so that in the case of noisy signals, audible and, thus, disturbing noise modulation occurs.

### SUMMARY OF THE INVENTION

Accordingly, the object of the invention is to insert, during signal transmission affected by noise, a noise in the echo time intervals after echo cancellation, such that disturbing/interfering noise and noise modulation are avoided.

This object is attained by the method described in the first claim and by the circuit arrangement described in the sixth claim.

The essence of the invention consists in the fact that after estimation of a noise level during speech pauses, a noise is added in the echo time intervals, so that through this noiseless insertion of a noise, naturally sounding speech transmission is achieved and noise modulation does not occur during speech pauses.

### BRIEF DESCRIPTION OF THE DRAWINGS

The invention will become more apparent by reference to the following description of an embodiment, taken in conjunction with the accompanying drawings, in which:

FIG. 1 is a block diagram of a circuit arrangement according to the invention;

FIG. 2 is a block diagram showing the functional units essential to the invention;

FIG. 3 is a plot of the noise suppression as a function of the noise-to-speech ratio; and

FIG. 4 is a block diagram of a variant of the circuit arrangement according to the invention.

### DESCRIPTION OF PREFERRED EMBODIMENTS

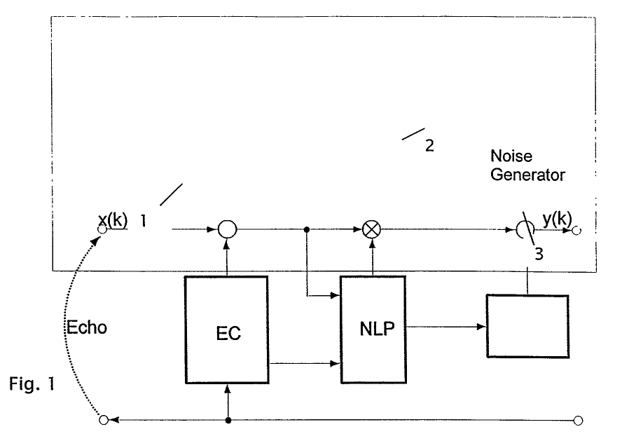

Referring to FIG. 1, the circuit arrangement according to the invention comprises an echo canceller 1, a processing unit with nonlinear function 2, and a noise generator 3. This circuit arrangement is inserted in a channel affected by echo. From the echo-containing signal x(k), the echo is subtracted by echo canceller 1, and processing unit with nonlinear function 2 eliminates residual echoes. Along with the residual echoes, however, the noise components of the signal are highly attenuated, so that a disturbing noise gap is obtained in the signal waveform. This noise gap is filled up with a noise provided by noise generator 3, with the level of the noise being controlled by processing unit with nonlinear function 2. The output of the circuit arrangement then provides an echo-free and naturally sounding output signal y(k), which contains a defined noise.

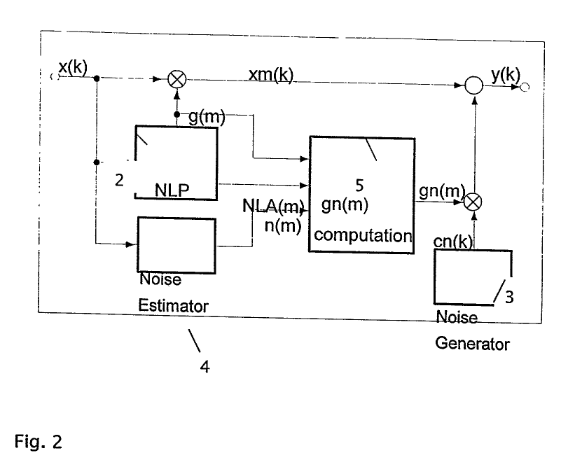

In the block diagram of FIG. 2, echo canceller 1 has been omitted, and processing unit with nonlinear function 2, noise generator 3, a noise level estimator 4, and a unit 5 for computing a weighting factor gn(m) are shown.

$$The weighting factor gn ( m ) is computed by \\ gn ( m ) = \{ \begin{matrix}if ( g ( m ) \geq NLG ( m ) ) \\ n ( m ) \cdot \frac{NLG ( m )}{g ( m )} \\ else n ( m )\end{matrix} \} \qquad ( 1 )$$

In FIG. 2 and Equation (1),

k=sampling instant

m=instants of subsampled values

NLG(m)=gain value (corresponding to the attenuation value) provided by the processing unit with nonlinear function outside the echo window in the presence of local noise (NLG=noise level gain)

$$NLA ( m ) = \frac{1}{NLG ( m )}$$

=attenuation value provided by

processing unit with nonlinear function 2 in the presence of

local noise without echo (NLA=noise level attenuation)

g(m)=instantaneous gain value provided by the processing unit with nonlinear function

n(m)=estimated noise level

x(k)=sampling sequence of the input signal

xm(k)=sampling sequence of the input signal amplified in the presence of speech or attenuated in the presence of echo

y(k)=sampling sequence of the output signal

cn(k)=sampling sequence provided by noise generator 3

Equation (1) describes that the weighting factor gn(m) can assume values between

$$n ( m ) \cdot \frac{NLG ( m )}{g ( m )}$$

and n(m). The value of the weighting factor gn(m) determines which portion of the noise cn(k), which is provided by noise generator 3, is added to a signal xm(k) that has been freed from echo and in which noise has been attenuated. In time intervals in which speech is being transmitted, the gain value g(m) provided by processing unit with nonlinear function 2 is very large, see Equation (1).

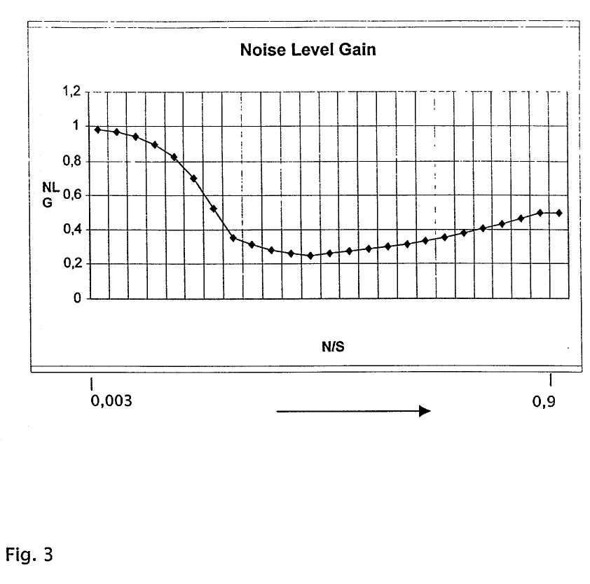

In nonlinear functions with noise suppression, the instantaneous gain value g(m) is dependent on the degree of noise suppression and is equal to the gain value NLG(m). The gain value NLG(m) can both be a fixed value and be adapted to the signal-to-noise ratio S/N or its reciprocal N/S, as shown in FIG. 3.

If g(m)≦NLG(m), the weighting factor gn(m) is determined essentially by the quotient

$$\frac{NLG ( m )}{g ( m )} ,$$

with the estimated noise level n(m) at the output of processing unit with nonlinear function 2 being reduced by this quotient, i.e., in time intervals in which speech is being transmitted, hardly any noise is added to the output signal.

In time intervals in which echo occurs, the gain value g(m) provided by processing unit with nonlinear function 2 becomes particularly small, in other words, the attenuation becomes very high, so that along with the echo, the noise level is highly attenuated. Thus, the inequality g(m) ≦NLG(m) no longer holds, and the weighting factor gn(m) is determined by the noise level n(m) estimated during speech pauses by noise level estimator 4. Hence, the transition between local speech activity and speech pauses is continuous and controlled by the speech level. Thus, during speech pauses, a synthetic noise is already present which can be adapted to the signal-to-noise ratio S/N or its reciprocal N/S as a function of the attenuation value NLA(m) provided by processing unit with nonlinear function 2.

Accordingly, the weighting factor gn(m) is advantageously determined by the course of the function g(m), which is implemented by processing unit with nonlinear function 2 in such a way that the nonlinear transfer characteristics of the human ear are taken into account. With this measure, the inertia of the human ear is replicated by effecting changes in the instantaneous gain value g(m) on a rapidly rising edge and a slowly falling edge.

A further improvement is achieved by taking into account the variation of the noise suppression NLG as a function of the noise (N)-to-speech (S) ratio, as shown in FIG. 3. Such a function can be implemented with a small amount of complexity in processing unit with nonlinear function 2. The function represented in FIG. 3,

$$NLG = f ( \frac{N}{S} ) ,$$

shows that in the presence of little noise N, noise reduction is not necessary; the gain is unity. With increasing noise N, the noise reduction must be increased. The function

$$NLG = f ( \frac{N}{S} )$$

passes through a minimum, since in the presence of severe speech interference, the noise reduction must be decreased in order to be able to distinguish speech from noise. By this course of the function, the noise reduction is adapted to the natural auditory sensation of the human ear, and the masking effects of the human ear are taken into account.

It is possible to compute the weighting factor gn(m) only when a speech pause is present. To do this, the circuit must be supplemented with a speech pause detector. The weighting factor gn(m) is then computed by

$$gn ( m ) = \{ \begin{matrix}{( \begin{matrix}\begin{matrix}if ( g ( m ) \geq NLG ( m ) ) \\ n ( m ) \cdot \frac{NLG ( m )}{g ( m )}\end{matrix} \\ else n\end{matrix} )}_{( m )} \\ else 0\end{matrix} if speech pause \qquad ( 2 )$$

This variant according to the invention has the advantage that during speech intervals, no noise is added to the output signal y(k).

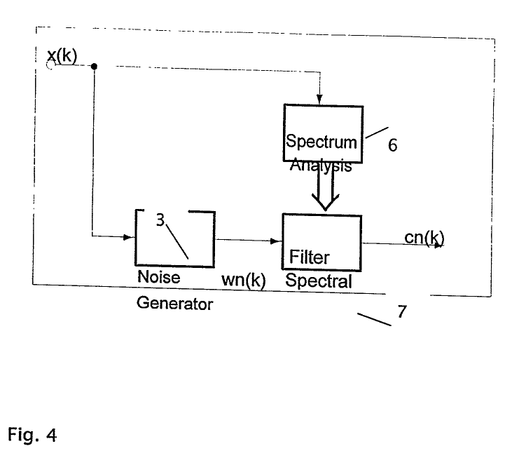

In order to further improve the natural speech impression and reduce the difference between natural ambient noise and added synthetic noise, the output wn(k) of noise generator 3 is filtered with a spectral filter 7, as shown in FIG. 4. The spectrum of the input signal x(k) is analyzed with a spectrum analyzer 6, whose output signal adjusts the spectral filter 7. This makes it possible to optimize the synthetic signal of the noise generator to the point that the natural noise and the added noise are hardly distinguishable from each other. Thus, natural background sounds such as traffic noise, machine noise, sports-ground atmosphere, or airport noise are essentially preserved.

With the invention, noiseless insertion of noise into noise gaps of a speech signal is implemented in an advantageous manner. Because of the subsampling, the amount of computation is small. By utilizing the nonlinear time response of the processing unit with nonlinear function 2, the nonlinear transfer characteristics of the human ear can be taken into account in the implementation of the invention with little programming effort.

Thus, on the one hand, the disturbing noise modulation is eliminated and, on the other hand, naturally sounding speech transmission is ensured.

1. A method of masking noise modulation and interfering noise during speech pauses in voice communication in telecommunications systems in which echo cancellers are used to suppress objectionable echoes, wherein during speech transmission affected by noise, the noise level is estimated during a speech pause, and during time intervals of the speech pause in which echoes occur and the echoes and the noise are suppressed, a noise provided by a noise generator is inserted in the resulting echo and noise gap such that the level of the inserted noise is adapted to the noise level during the speech pause.

2. A method as set forth in claim 1, wherein in telecommunications systems in which no correlation exists between transmitted speech signal and received echo, a compandor and/or a processing unit with nonlinear function are used to implement echo canceling techniques.

3. A method as set forth in claim 1, wherein the level of the noise provided by the noise generator is computed as a function of the estimated noise level (n(m)) according to the following rule for determining a weighting factor (gn(m)):
$$gn ( m ) = \{ \begin{matrix}if ( g ( m ) \geq NLG ( m ) ) \\ n ( m ) \cdot \frac{NLG ( m )}{g ( m )} \\ else n ( m )\end{matrix} \}$$
where
m=instants of the subsampled values
g(m)=instantaneous gain value provided by a processing unit with nonlinear function
NLG(m)=gain value provided by the processing unit with nonlinear function outside the echo window in the presence of local noise
n(m)=estimated noise level

4. A method as set forth in claim 3, wherein the weighting factor is computed only during a speech pause.

5. A method as set forth in claim 1, wherein the spectrum of the noisy speech signal is analyzed with a spectrum analyzer whose output adjusts a spectral filter with which the noise provided by the noise generator is then filtered and adapted to the spectrum of the noisy speech signal.

6. A circuit arrangement for carrying out the method, wherein the noisy speech signal is applied to the input of a processing unit with nonlinear function and to the input of a noise level estimator which have their outputs connected to the inputs of a computing unit, and that the output of the computing unit and the output of the noise generator are connected via control element to the echo- and noise-free, speech-signal-carrying line.

7. A circuit arrangement as set forth in claim 6, wherein the output of the noise generator is connected to the control element via a spectral filter, that the input of the spectral filter is connected to the output of a spectrum analyzer, and that the input of the spectrum analyzer is fed with the noisy speech signal.
